(19) United States
(12) Patent Application Publication
(10) Pub. No.: US 2003/0080260 A1
(43) Pub. Date: May 1, 2003

(54) Clevis hanger spacer for seismic applications

(76) Inventor: Brian Buck, Jackson, TN (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/285,903

(22) Filed: Nov. 1, 2002

Related U.S. Application Data
(60) Provisional application No. 60/330,860, filed on Nov. 1, 2001.

(51) Int. Cl. F16L 3/00

(52) U.S. Cl. 248/58; 248/62

(57) ABSTRACT

A clevis hanger comprising of an upper yoke having a pair of arms wherein each of the arms has an opening for receiving a tie rod, a lower yoke having a pair of arms wherein each of the arms has an opening for receiving the tie rod, the tie rod inserted through the openings in both the upper and lower yokes, the tie rod being of a general length and having an outer periphery, and a spacer having an outer body defining an interior and spaced ends defining an opening into the interior, the tie rod is received within the spacer interior such that the spacer body is generally parallel with the outer periphery of the tie rod along the general length of the tie rod, wherein the spacer substantially maintains the spacing between the arms of at least one of the yokes.

### CROSS REFERENCE TO RELATED APPLICATIONS

This patent application claims priority of U.S. Provisional Patent Application No. 60/330,860 entitled “Clevis Hanger Spacer for Seismic Applications” filed Nov. 1, 2001.

### FIELD OF THE INVENTION

This invention relates to a modification of a conventional clevis hanger of the type that supports a conduit of metal, concrete or plastic spaced from a ceiling or other structure so as to minimize the effects of seismic activity in the area in which the conduit is supported.

### BACKGROUND OF THE INVENTION

It has long been the practice in construction to support a number of items from the ceiling or similar overhead structures to facilitate installation and maintenance and for other reasons that will be apparent to those skilled in this practice.

One structure used in such environments is termed a clevis hanger which typically includes a yoke or belt that that will surround a conduit around a portion of its downwardly facing surface. The yoke is usually U shaped but may be square shaped to conform to the exterior shape of the conduit and terminates in two spaced hanger arms each of which is apertured adjacent its upper end.

Clevis hangers of various types have long been used in the construction field and in oil, gas and water distribution systems particularly where floor or plant space has been limited thus requiring the elevated suspension of conduits for these fluids. Conventionally, in modern construction, supports, called hanger rods, are first anchored to the ceiling of a structure and two yokes are employed for each hanger rod with one attached to a rod and the other surrounding the conduit to be suspended with the ends of the two yokes having apertures which are in alignment when assembled to receive a retaining or tie rod, the ends of which are threaded for receiving retention nuts or other locking elements.

In stable locations, the foregoing arrangement for a clevis hanger has enjoyed widespread use. However, in locations subject to periodic seismic tremors, such clevis hangers have presented a difficult problem for maintaining the suspended condition of the conduits carrying fluids such as those noted above. In industrial environments, where conduits which are suspended may also carry toxic fluids, stability in a seismic prone location has been a particularly severe problem in view of the expense and difficulty in reinforcing already installed clevis hangers. In the manufacturing and industrial sites, lengthy interruption of production could be encountered thereby discouraging installation of the desired or mandated reinforcement of the suspension system. To provide stability to a conventional clevis hanger where ground stability is in question, one practice has been to provide a bracing rod connected to the outside surface of the yolks at the point where the tie rod extends through the aligned apertures on one or both sides of the yokes. However, this construction has been found to be a source of damaging stress to the hanger rod and yokes as well as the tie rod of the conventional clevis hanger during seismic events.

### SUMMARY OF THE INVENTION

The present invention provides an inexpensive reinforcement device for a conventional clevis hanger which is easy to install and therefore economically attractive to a building or site owner or plant operator whether the hanger is already installed or in new construction. Preferably, a spacer bar is provided which can be slipped over the tie rod of the conventional clevis hanger without having to first remove the tie rod from the clevis hanger. A bracing rod can still be connected to the tie rod of the hanger and this may be required by local building codes. The spacer bar may, however, be used without a bracing rod as it will still provide greater stability for the assembled yokes of the conventional hanger.

By providing the spacer bar which can be installed without the removal of the tie rod, installation over a wide variety of sizes of the tie rods can be easily effected by even unskilled workman.

### BRIEF DESCRIPTION OF THE DRAWINGS

The foregoing and other advantages will become apparent as consideration is given to the following detailed description taken in conjunction with the accompanying drawings in which:

FIG. 1 is a perspective view of a conventional clevis hanger with a bracing rod and a spacer bar of the present invention installed on the tie rod, and

FIG. 2 is a perspective view of the spacer bar of the present invention.

### DETAILED DESCRIPTION OF THE INVENTION

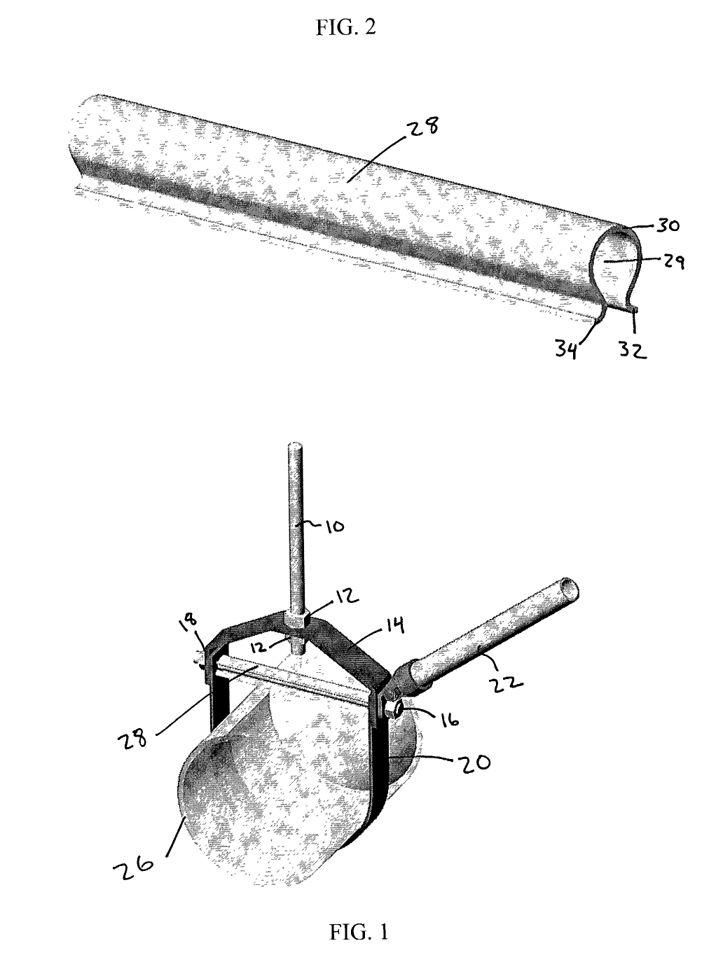

Referring to FIG. 1, there's shown a perspective view of a conventional clevis hanger which includes a hanger rod 10, the upper end of which is not shown but which is typically anchored in a concrete ceiling and may include an anchor in the form of an enlarged plate attached to the rod and which is embedded in concrete when the structure is cast. The opposite end of the rod 10 is threaded to receive the retention nuts 12 which are tightened on the threaded end of the rod 10 to engage an upper yoke 14 about an aperture provided through the center of the yoke 14 through which the rod 10 extends.

Yoke 14 terminates at its opposite ends in downwardly turning, flat segments 18 positionable in alignment with apertures in the upper ends, respectively, of a second U shaped yoke 20 to permit the assembled yokes to receive a tie rod 16 being of a general length and having an outer periphery through the aligned apertures of their opposite ends as shown in FIG. 1. The clevis hanger may also include a bracing rod 22 which terminates in a forked attachment head 24 which may also engage the tie rod 16 as shown in FIG. 1. In a number of the building codes, the use of a bracing rod 22 for the purpose of stabilizing a clevis hanger is required. However, it has been found that in the event of seismic tremors, the bracing rod 22 will often distort the yokes 14 and 20 relative to the hanger rod 10 of the hanger which may have been installed years earlier. Such distortion of the yokes can result in release of the suspended conduit 26. This probability is enhanced where the bracing rod head 24 pulls on the tie rod to an extent sufficient to deform one or both apertures of the yokes 14 and 20 allowing the tie rod 16 to be released.

Manufacturers of the yokes cannot possibly anticipate over the life of a clevis hanger design the magnitude of the seismic forces to which the yokes and a suspended conduit will be subjected. Therefore, in order to provide enhanced stability for a clevis hanger, the present invention provides a spacer bar 28 which can be easily inserted over the tie rod 16 and thus installed in an already functioning clevis hanger without requiring disturbance of the suspended conduit. To accommodate a broad range of sizes, the spacer bar 28 has an outer body which defines an interior 29 and preferably has flat ends such as shown at 30 and is U shaped and terminates in spaced ends 32 and 34 which define an opening into the spacer interior 29. The spacer bar 28 is preferably made of cast aluminum although other metals or plastic may be used. The spacer bar must be stiff enough longitudinally to resist anticipated forces that could be experienced. The thickness of the material of the bar 28 at least in the vicinity of the ends 32 and 34 should be such that the arms 32 and 34 are flexible enough to allow a snap fit over a tie rod 16. The tie rod 16 is received within the spacer interior 29 such that the spacer 28 is generally parallel with the outer periphery of the tie rod 16. The end surfaces 30 are preferably flat to stably engage the flat surface of the ends of the yoke 20 as shown in FIG. 1. In another embodiment where yoke 14, which terminates at its opposite ends in downwardly turning flat segments 18, is located inside yoke 20, the end surfaces 30 could stably engage the flat surface of the ends of yoke 18. This cooperation provides stability against distortion of the yokes 14 and 20 which may be induced by seismic activity acting through the bracing rod 22. Even in the absence of the bracing rod 22, the spacer bar 28 may be employed to provide structural stability to the shape of the assembled yokes 14 and 20 as will be apparent to those skilled in this practice.

It will be apparent also that various modifications may be made to the invention described above to achieve the stated objectives of the invention without departing from the scope of the invention.

We claim:

1. A clevis hanger comprising:
an upper yoke having a pair of arms wherein each of said arms has an opening for receiving a tie rod;
a lower yoke having a pair of arms wherein each of said arms has an opening for receiving a tie rod;
a tie rod inserted through said openings in both said upper and lower yokes, said tie rod being of a general length and having an outer periphery; and
a spacer having an outer body defining an interior with spaced ends defining an opening into said interior;
wherein said tie is rod received within said spacer interior such that said spacer body is generally parallel with said outer periphery of said tie rod along the general length of said tie rod and said spacer substantially maintains the spacing between the arms of at least one of said yokes.

2. The clevis hanger of claim 1 wherein said spacer snap fits over said tie rod.

3. The clevis hanger of claim 2 wherein said spacer is generally U-shaped.

4. The clevis hanger of claim 1 further including a bracing rod attached to said tie rod.

5. The clevis hanger of claim 1 wherein said spacer is removable from said tie rod without removing said tie rod from said openings after said tie rod has been inserted through said openings.

6. The clevis hanger of claim 1 wherein said spacer substantially maintains the spacing between the arms of said upper yoke.

7. The clevis hanger of claim 6 wherein said spacer is in communication with said upper yoke.

8. The clevis hanger of claim 1 wherein said spacer substantially maintains the spacing between the arms of said lower yoke.

9. The clevis hanger of claim 8 wherein said spacer is in communication with said lower yoke.

10. The clevis hanger of claim 1 wherein said spacer substantially maintains the spacing between the arms of both said upper and said lower yokes.

11. A clevis hanger spacer for an assembled clevis hanger including an upper and lower yoke assembly carrying a tie rod having an outer periphery, said upper and lower yoke assembly having spaced apart arms, said clevis hanger spacer comprising,
a rigid body having a generally U-shaped cross-section defining an interior for receiving said tie rod,
said body having a length less than said tie rod, wherein said body is attached to said tie rod between said assembled upper and lower yoke for maintaining the spacing between said arms of said upper and said lower yokes.
